(19) United States
(12) Patent Application Publication
(10) Pub. No.: US 2016/0116498 A1
(43) Pub. Date: Apr. 28, 2016

(54) METHOD AND DEVICE FOR MOTION COUNT DETECTION

(71) Applicant: Anhui Huami Information Technology Co., Ltd., Hefei (CN)

(72) Inventor: Haocheng WU, Hefei (CN)

(21) Appl. No.: 14/887,821

(22) Filed: Oct. 20, 2015

(30) Foreign Application Priority Data
Oct. 23, 2014 (CN) 201410571087.8

(51) Int. Cl. G01P 13/00; G01C 22/00

(52) U.S. Cl. CPC G01P 13/00; G01C 22/006

(57) ABSTRACT

A method and apparatus for detecting motion counts include: identifying one or more motion modes upon detection of acceleration; recording one or more motion modes to the list of motion modes limited with a maximum length and recording an occurrence number for each motion mode within the list of motion modes; upon detection of a motion mode, determining whether the detected motion mode is one of the motion modes within the list of motion modes; if the detected motion mode is one of the motion modes within the list of motion modes, increasing the occurrence number associated with the detected motion mode by one; if otherwise, appending the detected motion mode as a new motion mode to the list of motion modes and recording the occurrence number associated with the new motion mode as one. The method and apparatus effectively reduce misidentification rate, and have high extendibility.

### CROSS REFERENCE TO RELATED APPLICATION

This application claims priority to Chinese patent application no. 201410571087.8, filed Oct. 23, 2014 and incorporated herein by reference in its entirety.

### TECHNICAL FIELD

The present disclosure generally relates to smart devices, and more particularly, to a method and an apparatus for detecting motion counts.

### BACKGROUND

As smart devices being more and more popular nowadays, people become accustomed to use them to record their daily physical exercises, for instance, using smart phones or smart bracelets to record pace counts of walking or running every day. A basic requirement of such record function is to intelligently identify the pace counts of walking of a person, wherein such identification process being automatic and without human interference, is named as mode identification in computer science.

Mode identification of motions is defined as analyzing and classifying types of activities of a user using data generated by sensors in a smart device. The most basic and important sensor currently is accelerometer, or gravity sensor (G-sensor), or gravity transducer. It is an important part in mode identification of motions to identify the user's motion counts using an accelerometer.

As it be, many motions are periodic, or that two successive motions of an activity are essentially similar, such as walking, running, skipping, and sitting up. However, there are two major challenges in prior arts. (1) Low accuracy of identification. For instance, when using a keyboard, movements of hands of a user who wears a smart bracelet are classified and recorded as walking paces, wherein the movements are counted as valid motions, resulting in a high misidentification rate. In another example of skipping, as illustrated in FIG. 1A-1C, the waveforms 1A, 1B, and 1C respectively represent the acceleration values along an X-axis (a horizontal axis) before, during, and after the skipping of an athlete, with the horizontal axis being the numbers of sampling points and the vertical axis being the acceleration values relative to the acceleration of gravity. As indicated in FIG. 1, the athlete performs a series of warming-ups before the skipping, generating many noise waveforms; during the skipping, the athlete skips for 20 times, generating very periodic waveforms; and after the skipping, the generated waveforms become noise again, entirely different from the ones during the skipping. In prior arts, the motions before and after the skipping are counted as valid. (2) Low extendibility. Identifications of almost every type of motion are independently implemented without considering common features thereof, therefore each type of motion is independently programmed in embodiments, consuming large amount of time.

Thus, what is needed is a solution to those challenges to accurately detect counts of various types of motion modes for a user.

### SUMMARY

Disclosed herein are implementations of systems, methods and apparatus for detecting motion counts. In one aspect, the present disclosure includes a method for detecting motion counts. In another aspect, the present disclosure includes an apparatus for detecting motion counts, which comprises an identification module, a record module, a determination module, and an output module. The embodiments or implementations are configured as executable computer program instructions stored in computer readable and/or writable storage.

Features and advantages of the present disclosure will be set forth in the description of disclosure that follows, or will be apparent from or by practice of the disclosure.

### BRIEF DESCRIPTION OF THE DRAWINGS

The description here makes reference to the accompanying drawings wherein like reference numerals refer to like parts throughout the several views, and where:

FIGS. 1A-1C are exemplary waveforms of variations of acceleration in direction of X-axis for a skipping athlete;

FIG. 2 is a flow chart for a method of detecting motion counts according to an exemplary implementation in this disclosure;

FIG. 3 is an exemplary waveform for variations of acceleration values for a period of motion;

FIG. 4 is an exemplary diagram of frequency bands for motion modes;

FIG. 5 is an exemplary waveform for variations of acceleration in direction of X-axis before an adjustment;

FIG. 6 is an exemplary waveform for variations of acceleration in direction of X-axis after an adjustment;

FIG. 7 is a diagram for counts of an exemplary list of motion modes in direction along a single axis;

FIG. 8 is another flow chart for another method of detecting motion counts according to an exemplary implementation in this disclosure;

FIG. 9 is a diagram of an apparatus for detecting motion counts according to an exemplary implementation in this disclosure; and

FIG. 10 is a diagram of another apparatus for detecting motion counts according to another exemplary implementation in this disclosure.

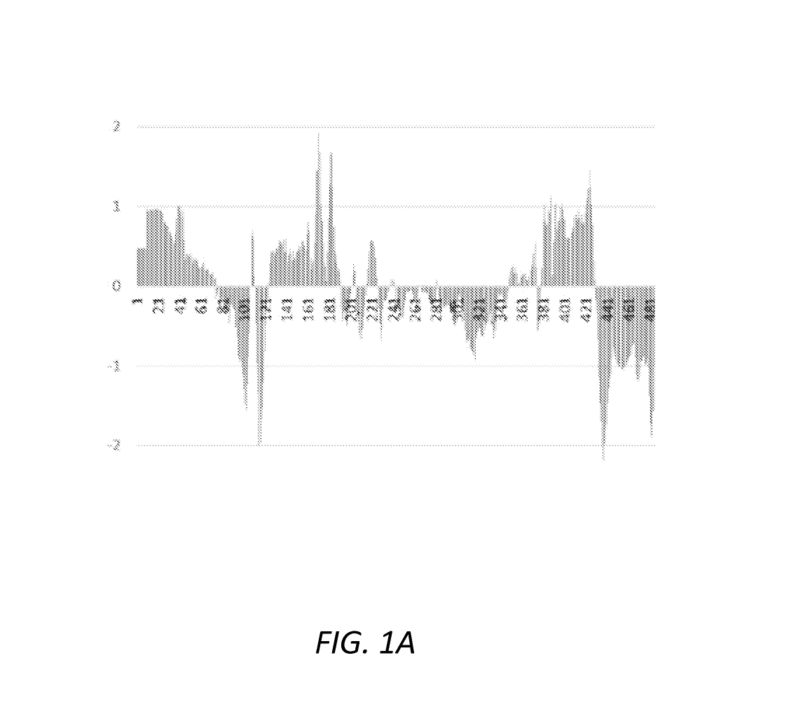

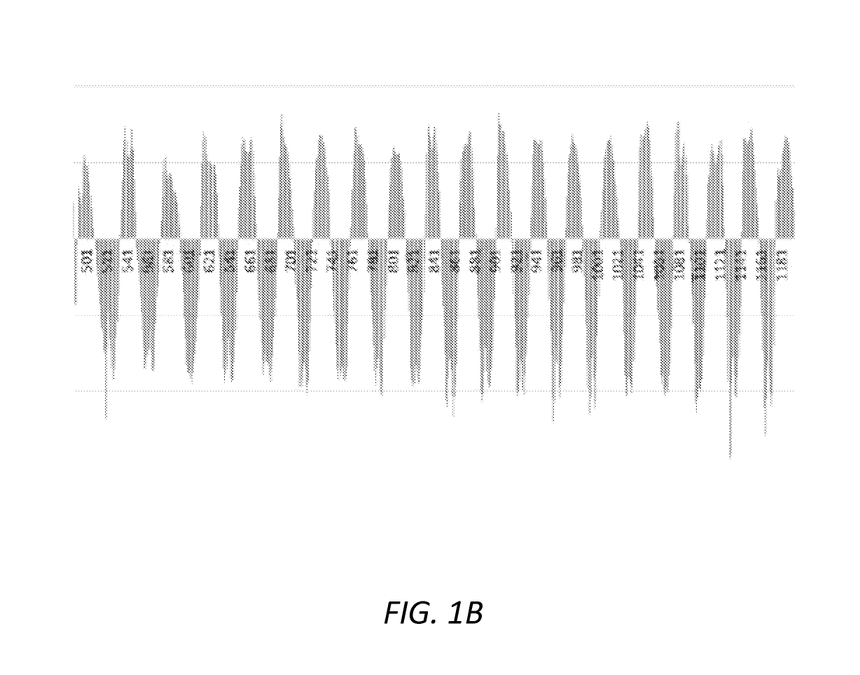

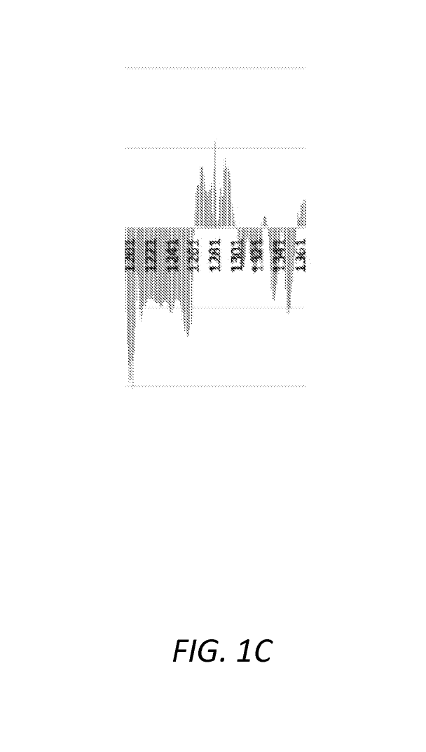

### DETAILED DESCRIPTION OF THE EMBODIMENTS

Example implementations of the present disclosure will be described below with reference to the accompanying drawings. The same numbers across the drawings set forth in the following description represent the same or similar elements, unless differently expressed. The implementations set forth in the following description do not represent all implementations or embodiments consistent with the present disclosure; on the contrary, they are only examples of apparatuses and methods in accordance with some aspects of this disclosure as detailed in the claims.

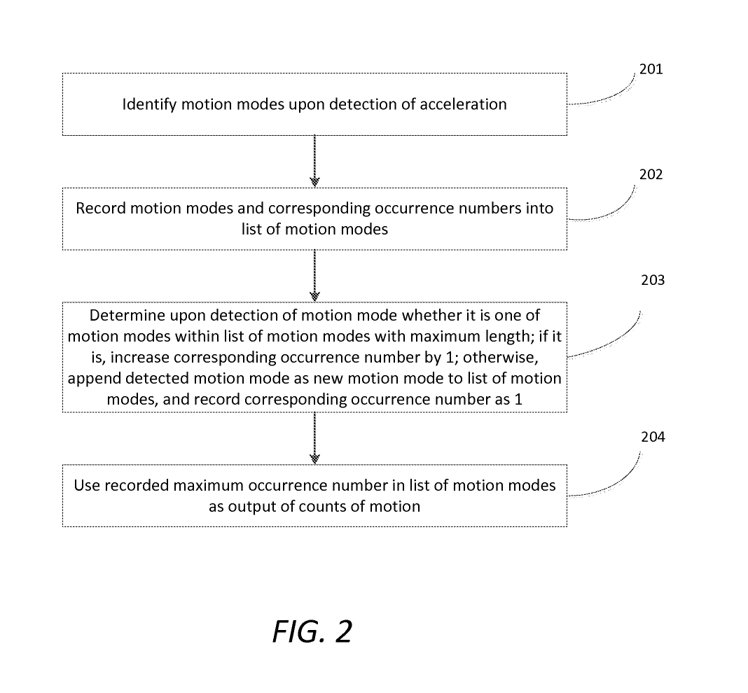

FIG. 2 is a flow chart for a method of detecting motion counts according to an exemplary implementation, wherein the method is used in smart devices such as smart phones, smart bracelets, smart watches, smart rings, smart necklaces, smart clips, smart belts, head mounted displays, and so forth. As illustrated in FIG. 2, the method consists of steps 201-204 set forth in the following.

At step 201, one or more motion modes are identified upon detection of acceleration. In one implementation, an accelerometer is able to detect variations of acceleration for various movements such as lifting, falling, and wobbling, wherein acceleration values are monitored by the accelerometer by sampling in pre-set frequency, such as 10 HZ, or sampling 10 times every second. Every sample point thereof records the acceleration values along three standard coordinate axes with respect to the accelerometer, wherein the coordinate axes are isolated from the orientation in physical space of the sensor. A waveform for each standard coordinate axis is constructed based on the numbering and values of the sampling points. The motion modes may be walking, hiking, running, and so forth.

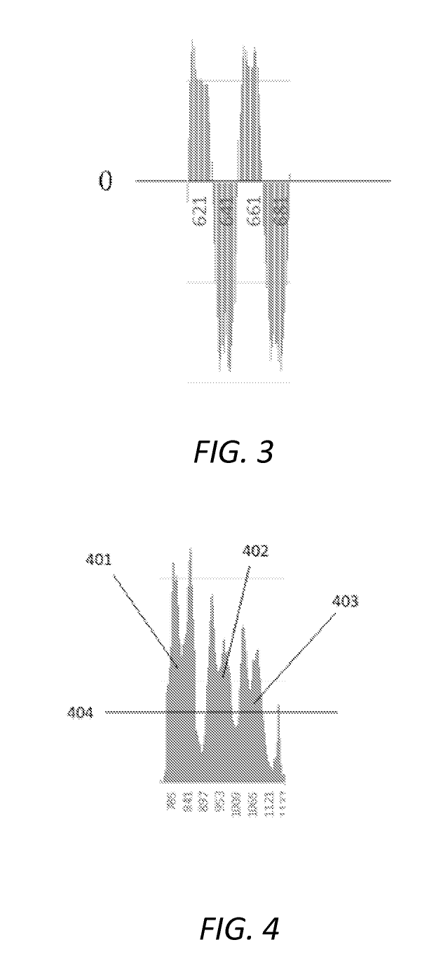

The identification of motion modes at step 201 may be implementing as the following method in one implementation. One or more motion modes may be identified upon detection of acceleration in accordance with one or more pre-set identification rules, wherein the pre-set identification rules may include identifying a motion with acceleration of pre-set variation characteristics as a motion mode, as illustrated in FIG. 3. The pre-set variation characteristics may include variation characteristics of acceleration waveform data, such as turning from zero to a positive value, turning from a positive value to zero, turning from zero to a negative value, and turning from a negative value to zero; or the pre-set variation characteristics include variation characteristics of acceleration waveform data, such as turning from zero to a negative value, turning from a negative value to zero, turning from zero to a positive value, and turning from a positive value to zero. The variations of the characteristics may be regarded as a motion period, wherein each variation of the characteristics in each motion period may include characteristic values such as: 1. Numbers of sampling points: the numbers of sampling points included in positive or negative windows; 2. Mean values: the mean values of sampling points included in positive or negative windows; 3. Standard deviations: the standard deviations of sampling points included in positive or negative windows; 4. Maximums of absolute values: the maximums of absolute values of sampling points included in positive or negative windows; 5. Numbers of frequency bands: the numbers of sub-windows with statistical absolute values exceeding a set threshold value, as illustrated in FIG. 4, wherein 401, 402, and 403 are frequency bands and 404 is a threshold value; 6. Maximums of frequency bandwidths: the maximums of the numbers of sampling points included in all frequency bands. As illustrated in FIG. 4, frequency band 401 includes the most sampling points compared to frequency bands 402 and 403, therefore has the widest frequency bandwidth. The characteristics of each motion mode may be accurately represented by aforementioned characteristic values.

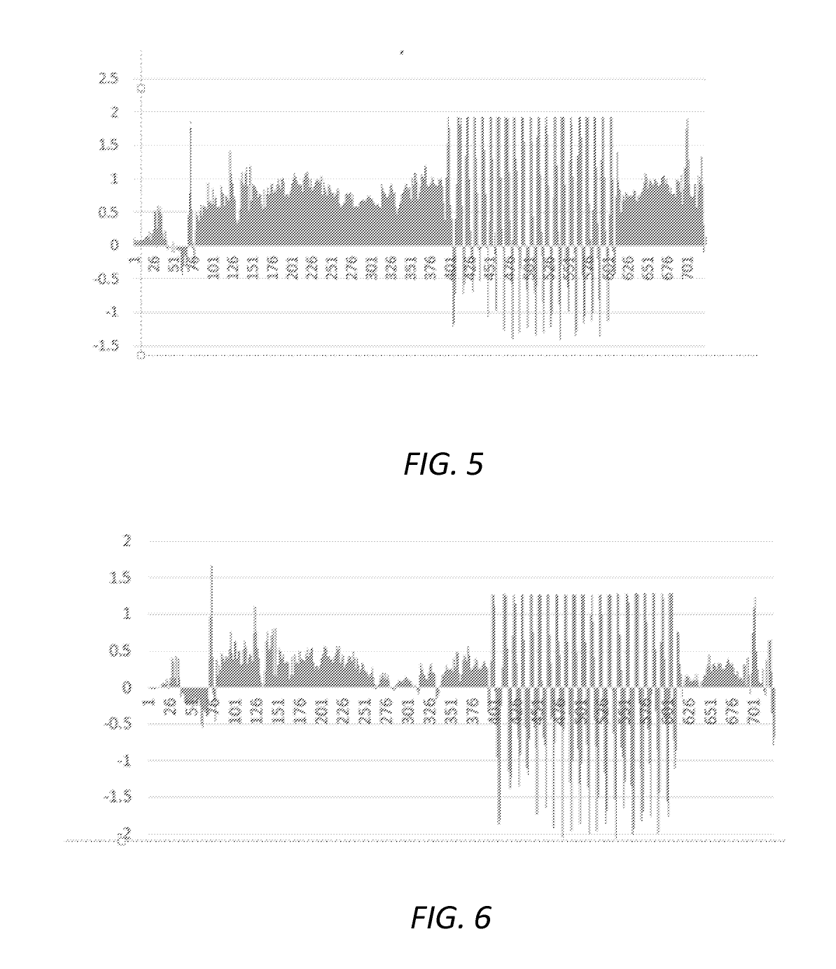

However, the above-mentioned method at step 201 has a problem in concrete implementations: as illustrated in FIG. 5, the entirety of the acceleration values may be shifted either upward or downward, making the entirety variates above or under the zero-axis without much occurrences of crossing the zero-axis. To balance the ratio of positive and negative values respectively above and under the zero-axis, the original acceleration values may be replaced by a difference value between the current acceleration value and a mean acceleration value of all sampling points. For example, for X-axis, a formula for calculating the mean value of the (n+1)^{th} sampling point along the direction of X-axis is:

$${Avg}_{n + 1} = \frac{{Avg}_{n} * n + {x}_{n + 1}}{n + 1} = {Avg}_{n} + \frac{{x}_{n} - {Avg}_{n}}{n + 1}$$

Wherein Avgₙ₊₁ is the mean value of the (n+1)^{th} sampling point, Avgₙ is the mean value of the n^{th} sampling point, xₙ₊₁ is the acceleration value of the (n+1)^{th} sampling point, and xₙ is the acceleration value of the n^{th} sampling point. In other words, the mean value of the (n+1)^{th} sampling point Avgₙ₊₁ may only need to be adjusted on the basis of Avgₙ. Then, the original xₙ₊₁ may be replaced by Dₙ defined as:

Dₙ=xₙ−Avgₙ

FIG. 6 is the waveform for the variations of the single-axis acceleration after the adjustment, which illustrates a relatively balanced ratio above and under the zero-axis.

At step 202, one or more motion modes and the associated occurrence numbers thereof are recorded into a list of motion. Nodes of the list of motion modes store motion modes and counts of occurrences for the motion modes. In one implementation, step 202 may be implemented as assigning a node for each motion mode of one or more motion modes within the list of motion modes in a descending order of the occurrence numbers, then recording said motion mode and the associated occurrence number, wherein the motion mode with the largest occurrence number associates with a head node, and the motion mode with the second largest occurrence number associates with a second node, and the rest may be deduced by analogy. In concrete implementation, this method may use Bubble Sort to maintain the descending order of the list to ensure that the head node records the motion mode with the maximum occurrence number.

At step 203, upon detection of one motion mode, it is determined whether the detected motion mode is one of the motion modes within the list of motion modes limited with a maximum length. If the detected motion mode is one of the motion modes within the list of motion modes, the occurrence number associated with the detected motion mode is increased by one; otherwise, the detected motion mode is appended as a new motion mode to the list of motion modes, and the occurrence number associated with the new motion mode is recorded as one in the list of motion modes. The list of motion modes limited with a maximum length therein means that the length of the list of motion modes does not exceed a set maximum length, for instance, a list with five nodes or less.

In one implementation, the determination of whether the detected motion mode is one of the motion modes within the list of motion modes may be implemented as follows. The detected motion mode may be compared to the motion mode recorded in each node within the list of motion modes by a successive order starting from the head node, and whether the detected motion mode is one of the motion modes within the list of motion mode is determined. The head node represents the correct motion mode for a motion.

In another implementation, the determination of whether the detected motion mode is one of the motion modes within the list of motion modes in step 203 may be implemented as sub-steps (1)-(3) set forth as follows.

(1) The degree of similarity between the detected motion mode and each motion mode within the list of motion modes is determined, wherein the degree of similarity between two motion modes may be calculated with the characteristic values of the two motion modes determined by the exemplary method of step 201. The similarity of Euclidian distance therein is defined as follows:

Given two vectors A and B of the same dimension n, wherein A={a₁,a₂, . . . , aₙ}, B={b₁,b₂, . . . , bₙ}, the Euclidian distance d between the two vectors is calculated by:

$$d = \sqrt[2]{{( {a}_{1} - {b}_{1} )}^{2} + {( {a}_{2} - {b}_{2} )}^{2} + … + {( {a}_{n} - {b}_{n} )}^{2}}$$

The similarity of Euclidian distance sim is calculated by:

$$sim = \frac{1}{1 + d}$$

(2) If the degree of similarity between the detected motion mode and one of the motion modes within the list of motion modes is equal or greater than a pre-set value, the detected motion mode is decided to be said motion mode. According to the similarity of Euclidian distance between two motion modes calculated by the formula in sub-step (1), the two motion modes may be considered to be similar when the similarity of Euclidian distance sim is equal or greater than a pre-set value, wherein different pre-set values may be set for different motion modes.

(3) If the degree of similarity between the detected motion mode and any of the motion modes within the list of motion modes is less than the pre-set value, the detected motion mode is decided to be none of the motion modes within the list of motion modes.

The aforementioned method may implement the motion counting with ease and accuracy, therefore may effectively reduce misidentification rate.

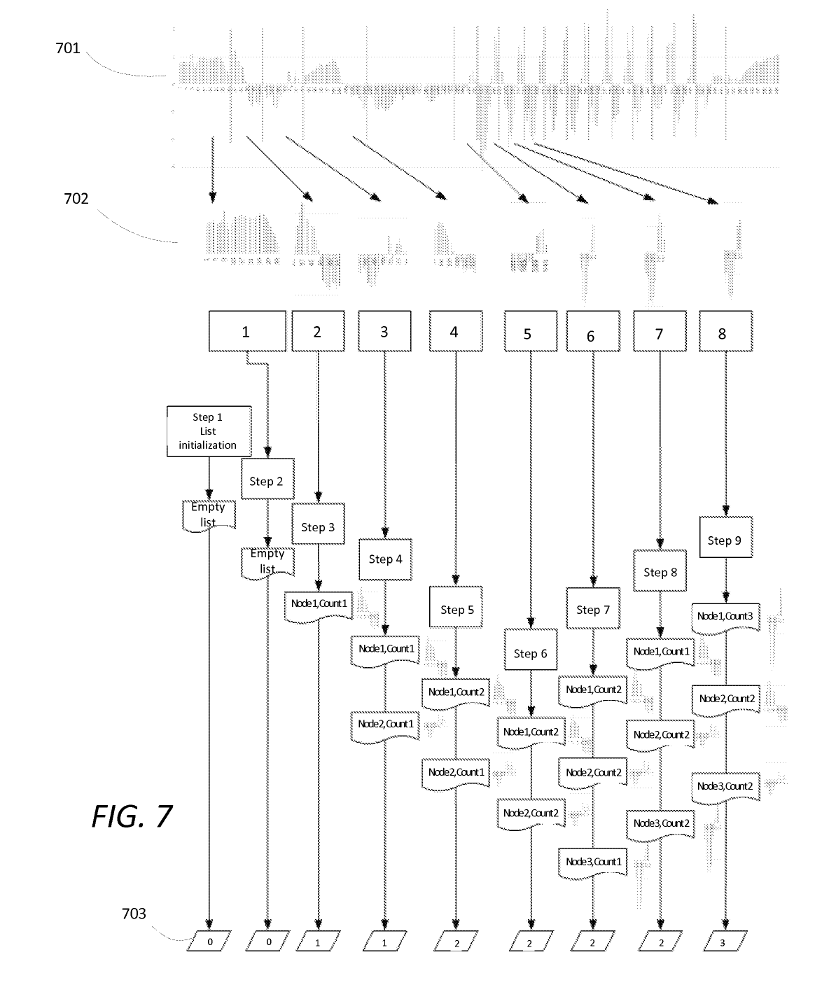

In another implementation, the list of motion modes has five nodes or less, wherein when the similarity between motion modes is less than the pre-set value, or that the motion modes are different, the motion modes are stored in the nodes, for five nodes storing five different motion modes. There is one number stored in each node to record the numbers of motion modes that are similar to this node. As illustrated in FIG. 7, numbers 1-8 respectively represent eight motion modes, with motion mode 1 being invalid due to timeout and motion modes 2-8 being valid, wherein 701 shows the original data measured by the accelerometer, 702 shows the sliced original data, and 703 shows the motion counts. The nodes in the entire list of motion modes are arranged by a descending order of counts. For every new motion mode, the similarity comparison between the new motion mode and each of the motion mode in the list of motion modes is performed starting from the first node; if the two motion modes are found similar, the associated motion counts in the list is increased by one and the mean value of characteristic values is updated; if the two motion modes are found not similar, the comparison continues to the next node. When the operation of increasing by one is performed, if the resulted count is greater than any one of the antecedent nodes, the descending order of the list of motion modes is maintained by a bubble sort. If the comparison continues to the last node without finding similar pairs of motion modes, the last node is removed and replaced by this new motion mode which is appended at the end of the list, with the associated count set as one. The final valid motion mode is always represented by the values of all the counts of the first node. FIG. 7 illustrates the exemplary method for counting a single-axis motion, however, the final counts of the motion mode will output the maximum value of the current counts of motion modes among three (or two) coordinate axes.

In one implementation, if the detected motion mode is none of the motion modes within the list of motion modes, the detected motion mode is appended as a new motion mode to the list of motion modes, and the associated occurrence number is recorded as one, wherein concrete steps may be implemented as follows. If the detected motion mode is none of the motion modes within the list of motion modes, the detected motion mode is regarded as a new motion mode. If the length of the list of motion modes does not exceed a set maximum length, the detected motion mode is directly appended as a new motion mode to the end of the list of motion modes, and the associated occurrence number is recorded as one; otherwise, the motion mode with the least occurrence number is firstly removed from the list of motion modes, the detected motion mode is secondly appended as a new motion mode, and the occurrence number of the new motion mode is recorded as one in the end node.

At step 204, a recorded maximum occurrence number in the list of motion modes is outputted as motion counts, wherein steps 201-203 are performed independently for every single coordinate axis to record motion counts, and the actual motion counts are the motion counts of the axis with the greatest motion counts.

The method provided by the implementations in this disclosure determines whether current motion mode is one of the motion modes within the list of motion modes, and increasing the motion counts by one if current motion mode is one of the motion modes in the list, while not increasing the motion count if otherwise. The method records motion counts with ease and accuracy, effectively reduces the misidentification rate, raises the rate of accuracy, and attains high extendibility for that the method is applicable to motion counts of various motion modes based on the various motion modes stored in the list of motion modes.

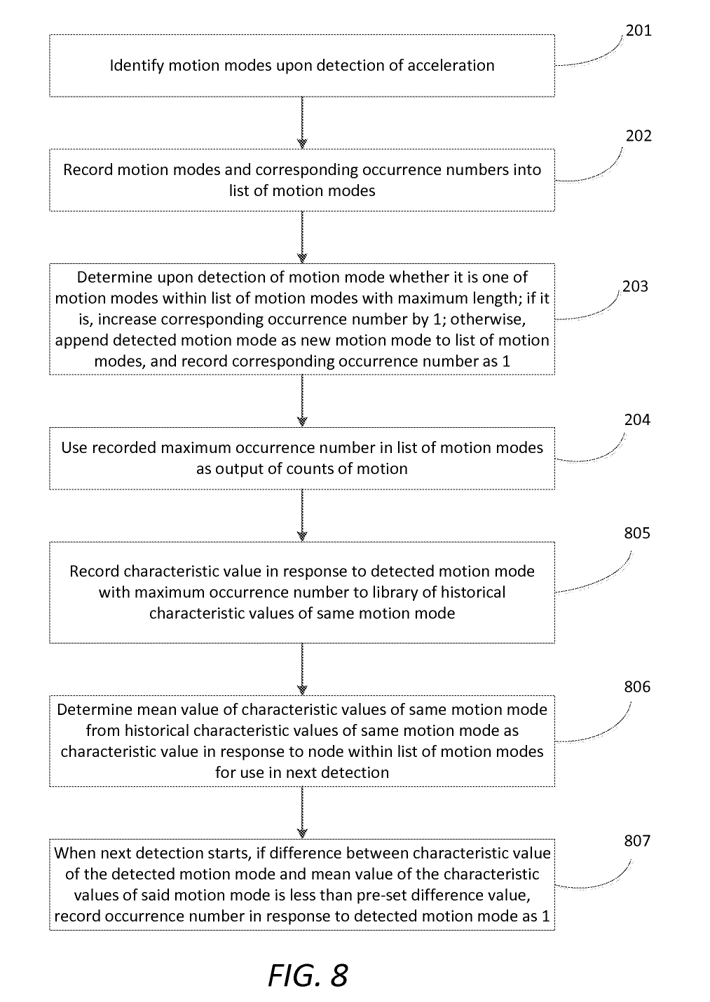

As illustrated in FIG. 8, after step 204, the aforementioned method may further include the following steps.

At step 805, a characteristic value associated with the detected motion mode with a maximum occurrence number is recorded to a library of historical characteristic values of the same motion mode.

At step 806, a mean value of the characteristic values of the motion mode is determined from the historical characteristic values of the same motion mode as the characteristic value of the corresponding node within the list of the motion modes for use in next detection.

At step 807, when the next detection starts, if a difference between the characteristic value of the detected motion mode and the mean value of the characteristic values of said motion mode is less than a pre-set difference value, the occurrence number associated with the detected motion mode is recorded as one.

When the methods in steps 201-204 are used in an application for real-time display of counts of a motion mode, an undesirable value from noise will be displayed for noises before the motion, wherein user experience is degraded, although said value is not counted in the final correct value, for that the count value resulted from noise is displayed even before the user starts exercises. Steps 805-807 may provide a solution for such problem, which is set forth as follows.

Historical data (for instance, historical characteristic values) may be used to filter motion modes in new data, wherein the characteristic values of motion modes resulted from steps 201-204 measured from a plurality of users doing a plurality of exercises may be used to filter future candidate motion modes obtained from sliced new data. The following steps (a)-(c) are described for skipping as an example.

(a) When a plurality of users performs a plurality of skipping, the skipping data of the users is obtained, of which the characteristics are represented in the first node of the list of motion modes.

(b) The first nodes of all users are extracted and stored to calculate the mean value of characteristic values in this node for all the users, wherein a mean characteristic-value vector of skipping is obtained for a correct skipping mode for all the users.

(c) When a new user performs skipping, a similarity threshold value is set, wherein the noise of the new user's motion mode will be filtered before being appended to the list of motion modes, for the noise thereof is not similar to the mean characteristic value of skipping, therefore no noise will be counted before the skipping motion starts and count values will be only displayed upon the start of skipping motion.

The aforementioned methods may accurately identify future motion modes by using stored mean characteristic values, and will not display noise as motion counts for real-time motion-count display, wherein the user experience is improved.

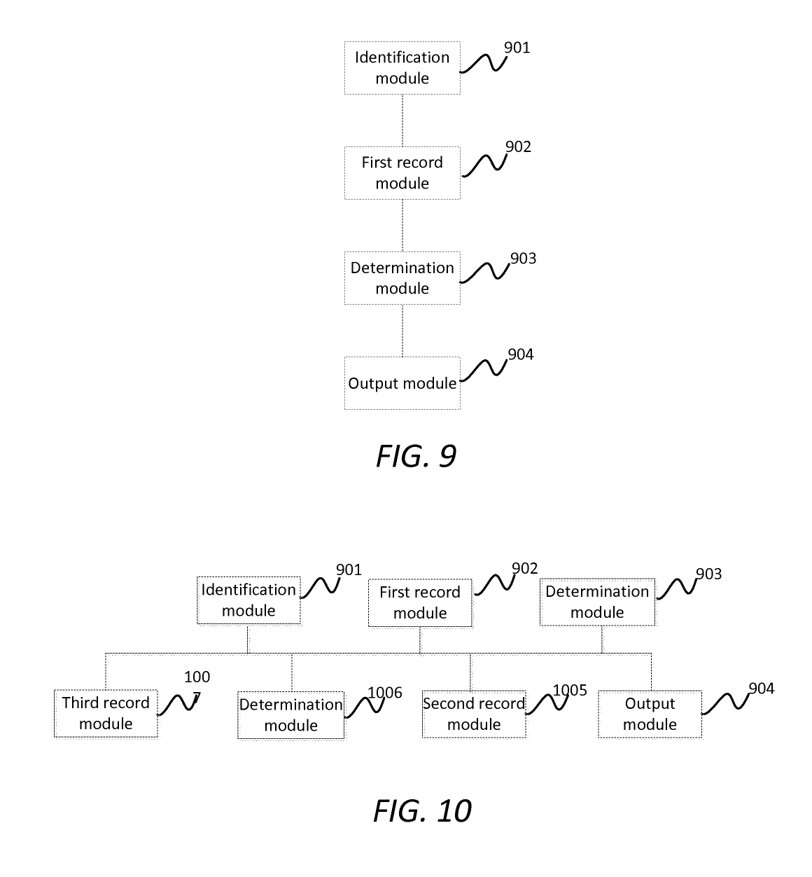

FIG. 9 is a diagram of a communication apparatus for detecting motion counts according to an exemplary implementation. The communication apparatus illustrated in FIG. 9 may include:

an identification module 901 which is used to identify one or more motion modes upon detection of acceleration;

a first record module 902 which is used to record one or more motion modes to a list of motion modes, and record an occurrence number for each motion mode within the list of motion modes;

a determination module 903 which is used upon detection of a motion mode to determine whether the detected motion mode is one of the motion modes within the list of motion modes; if the detected motion mode is one of the motion modes within the list of motion modes, the occurrence number associated with the detected motion mode is increased by one; otherwise, the detected motion mode is appended as a new motion mode to the list of motion modes, wherein if the length of the list of motion modes does not exceed a set maximum length, the detected motion mode is directly appended as a new motion mode to the end of the list of motion modes with the associated occurrence number recorded as one, and otherwise, the motion mode with the least occurrence number is firstly removed from the list of motion modes, the detected motion mode is secondly appended as a new motion mode, and the occurrence number of the new motion mode is recorded as one in the end node; and

an output module 904 which uses a recorded maximum occurrence number in the list of motion modes as an output of motion counts.

In one implementation, the identification module 901 may include an identification sub-module which is used to identify one or more motion modes according to one or more pre-set identification rules upon detection of acceleration; wherein the pre-set identification rules comprises: identifying a motion which has acceleration with pre-set variation characteristics as a motion mode, wherein the pre-set variation characteristics include variation characteristics of turning from zero to a positive value, turning from a positive value to zero, turning from zero to a negative value, and turning from a negative value to zero; or the pre-set variation characteristics include variation characteristics of turning from zero to a negative value, turning from a negative value to zero, turning from zero to a positive value, and turning from a positive value to zero.

In one implementation, the first record module 902 may include a first record sub-module which assigns a node for each motion mode of one or more motion modes within the list of motion modes by a descending order of the occurrence numbers, and records the motion mode and the occurrence number for each node, wherein the motion mode with the largest occurrence number associates with a head node, and the motion mode with the second largest occurrence number associates with a second node, and the rest may be deduced by analogy. The determination module 903 may include a first determination sub-module which compares the detected motion mode to the motion mode recorded in each node within the list of motion modes by a successive order starting from the head node, and determines whether the detected motion mode is one of the motion modes within the list of motion mode.

In another implementation, the determination module 903 may include a second determination sub-module, wherein if the detected motion mode is none of the motion modes within the list of motion modes, the second determination sub-module determines whether the length of the list of motion modes exceeds a set maximum length. If the length of the list of motion modes does not exceed the set maximum length, the second determination sub-module directly appends the detected motion mode as a new motion mode to the end of the list of motion modes, and records the associated occurrence number as one in the list of motion modes; otherwise, the second determination sub-module firstly removes the motion mode with the least occurrence number from the list of motion modes, and secondly appends the detected motion mode as a new motion mode to the end of the list of motion modes, and then records the associated occurrence number as one in the end node.

In another implementation, the determination module 903 may include:

a third determination sub-module which determines the degree of similarity between the detected motion mode and each motion mode within the list of motion modes;

a first decision sub-module which decides that the detected motion mode is said motion mode if the degree of similarity between the detected motion mode and one of the motion modes within the list of motion modes is equal or greater than a pre-set value; and

a second decision sub-module which decides that the detected motion mode is none of the motion modes within the list of motion modes if the degree of similarity between the detected motion mode and any of the motion modes within the list of motion modes is less than the pre-set value.

In one exemplary implementation as illustrated in FIG. 10, the aforementioned apparatus may include:

a second record module 1005 which records a characteristic value for the detected motion mode with a maximum occurrence number to a library of historical characteristic values of the same motion mode;

a determination module 1006 which determines a mean value of the characteristic values for a motion mode according to the historical characteristic values of the same motion mode as the characteristic value of the corresponding node within the list of the motion modes for use in next detection; and

a third record module 1007, wherein when next detection starts, if a difference between the characteristic value of the detected motion mode and the mean value of the characteristic values of the same motion mode is less than a pre-set difference value, the third record module records the occurrence number associated with the detected motion mode as one.

The apparatuses described by the implementations in this disclosure determines whether current motion mode is one of the motion modes within the list of motion modes, and increasing the motion counts by one if current motion mode is one of the motion modes in the list, while not increasing the motion count if otherwise. The apparatuses records motion counts with ease and accuracy, effectively reduces the misidentification rate, raises the rate of accuracy, and attains high extendibility since the method is applicable to motion counts of various motion modes due to the various motion modes in the list of motion modes.

Technical specialists skilled in the art should understand that, the implementations in this disclosure may be implemented as methods, systems, or computer program products. Therefore, this disclosure may be implemented in forms of complete hardware implementation, complete software implementation, and a combination of software and hardware implementation. Further, this disclosure may be embodied as a form of one or more computer program products which are embodied as computer executable program codes in computer writable storage media (including but not limited to disk storage and optical storage).

This disclosure is described in accordance with the methods, apparatuses (systems), and flow charts and/or diagrams of computer program products of the implementations, which should be comprehended as each flow and/or box of the flow charts and/or diagrams implemented by computer program instructions, and the combinations of flows and/or boxes in the flow charts and/or diagrams. The computer program instructions therein may be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flow charts and/or one or more boxes in the diagrams.

The computer program instructions may also be stored in a computer readable storage which is able to boot a computer or other programmable data processing device to a specific work mode, wherein the instructions stored in the computer readable storage produce a manufactured product containing the instruction devices which implements the functions designated by one or more flows in the flow charts and/or one or more boxes in the diagrams.

The computer program instructions may also be loaded to a computer or another programmable data processing device to execute a series of operating procedures in the computer or the other programmable data processing device to produce a processing implemented by the computer, which the computer program instructions executed in the computer or the other programmable data processing device provide the operating procedures for the functions designated by one or more flows in the flow charts and/or one or more boxes in the diagrams.

Apparently, the technical specialists skilled in the art may perform any variation and modification to this disclosure within the principles and scope of this disclosure. Therefore, if the variations and modifications herein are within the scope of the claims and other equivalent techniques herein, this disclosure intends to include the variations and modifications thereof.

What is claimed is:

1. A method for detecting motion counts, comprising:
identifying one or more motion modes upon detection of acceleration;
recording one or more motion modes into a list of motion modes, and recording an occurrence number for each motion mode in the list of motion modes;
upon identification of a motion mode:
determining whether the detected motion mode is one of the motion modes within the list of motion modes limited with a maximum length;
based on a determination that the detected motion mode is one of the motion modes within the list of motion modes, increasing the occurrence number associated with the detected motion mode by one;
based on a determination that the detected motion mode is none of the motion modes within the list of motion modes, appending the detected motion mode as a new motion mode to the list of motion modes, and recording the occurrence number associated with the new motion mode as one in the list of motion modes; and
using a recorded maximum occurrence number in the list of motion modes as an output of motion counts.

2. The method of claim 1, wherein the identifying one or more motion modes upon detection of acceleration, further comprises:
upon detection of acceleration, identifying one or more motion modes in accordance with one or more pre-set identification rules, which further comprises:
identifying a motion which has acceleration with pre-set variation characteristics as a motion mode, wherein the pre-set variation characteristics include variation characteristics of turning from zero to a positive value, turning from a positive value to zero, turning from zero to a negative value, and turning from a negative value to zero; or the pre-set variation characteristics include variation characteristics of turning from zero to a negative value, turning from a negative value to zero, turning from zero to a positive value, and turning from a positive value to zero.

3. The method of claim 1, wherein the recording one or more motion modes into the list of motion modes and the recording the occurrence number for each motion mode in the list of motion modes, further comprise:
by a descending order of the occurrence numbers, assigning a node for each motion mode of one or more motion modes within the list of motion modes, and recording the motion mode and the occurrence number of the motion mode in the node, wherein the motion mode with the largest occurrence number associates with a head node, and the motion mode with the second largest occurrence number associates with a second node, and the rest may be deduced by analogy.

4. The method of claim 1, wherein the determining whether the detected motion mode is one of the motion modes within the list of motion modes, further comprises:
comparing the detected motion mode to the motion mode recorded in each node within the list of motion modes by a successive order starting from the head node, and determining whether the detected motion mode is one of the motion modes within the list of motion mode.

5. The method of claim 3, wherein based on a determination that the detected motion mode is none of the motion modes within the list of motion modes, the appending the detected motion mode as a new motion mode to the list of motion modes, and the recording the occurrence number associated with the new motion mode as one in the list of motion modes, further comprise:
based on a determination that the detected motion mode is none of the motion modes within the list of motion modes, determining whether the length of the list of motion modes exceeds a set maximum length;
upon a determination that the length of the list of motion modes does not exceed a set maximum length, directly appending the detected motion mode as a new motion mode to the end of the list of motion modes, and recording the occurrence number associated with the new motion mode as one in the list of motion modes;
upon a determination that the length of the list of motion modes exceeds a set maximum length, firstly removing the motion mode with the least occurrence number from the list of motion modes, and secondly appending the detected motion mode as a new motion mode to the end of the list of motion modes and recording the occurrence number associated with the new motion mode as one in the end node.

6. The method of claim 1, wherein the determining whether the detected motion mode is one of the motion modes within the list of motion modes, further comprises:
determining the degree of similarity between the detected motion mode and each motion mode within the list of motion modes;
upon a determination that the degree of similarity between the detected motion mode and one of the motion modes within the list of motion modes is equal or greater than a pre-set value, deciding that the detected motion mode is said motion mode; and
upon a determination that the degree of similarity between the detected motion mode and any of the motion modes within the list of motion modes is less than the pre-set value, deciding that the detected motion mode is none of the motion modes within the list of motion modes.

7. The method of claim 6, wherein the using a recorded maximum occurrence number in the list of motion modes as an output of motion counts, further comprises:
recording a characteristic value associated with the detected motion mode with a maximum occurrence number to a library of historical characteristic values of the same motion mode, and determining a mean value for the characteristic values of the same motion mode from the historical characteristic values of the same motion mode as the characteristic value associated with the node within the list of the motion modes for use in next detection; and
when next detection starts, upon a determination that a difference between the characteristic value of the detected motion mode and the mean value of the characteristic values of the same motion mode is less than a pre-set difference value, recording the occurrence number associated with the detected motion mode as one.

8. An apparatus for detecting motion counts, comprising:
an identification module, wherein the identification module identifies one or more motion modes upon detection of acceleration;
a first record module, wherein the first record module records one or more motion modes to a list of motion modes and records an occurrence number for each motion mode within the list of motion modes;
a determination module, wherein upon detecting a motion mode, the determination module determines whether the detected motion mode is one of the motion modes within the list of motion modes; upon a determination that the detected motion mode is one of the motion modes within the list of motion modes, the determination module increases the occurrence number associated with the detected motion mode by one; and upon a determination that the detected motion mode is none of the motion modes within the list of motion modes, the determination module appends the detected motion mode as a new motion mode to the list of motion modes and records the occurrence number associated with the new motion mode as one in the list of motion modes; and
an output module, wherein the output module uses a recorded maximum occurrence number in the list of motion modes as an output of motion counts.

9. The apparatus in claim 8, wherein the identification module comprises:
an identification sub-module, wherein upon detection of acceleration, the identification sub-module identifies one or more motion modes in accordance with one or more pre-set identification rules; wherein the pre-set identification rules comprises:
identifying a motion which has acceleration with pre-set variation characteristics as a motion mode, wherein the pre-set variation characteristics include variation characteristics of turning from zero to a positive value, turning from a positive value to zero, turning from zero to a negative value, and turning from a negative value to zero; or the pre-set variation characteristics include variation characteristics of turning from zero to a negative value, turning from a negative value to zero, turning from zero to a positive value, and turning from a positive value to zero.

10. The apparatus in claim 8, wherein the first record module comprises:
a first record sub-module, wherein the first record sub-module assigns a node for each motion mode of one or more motion modes within the list of motion modes by a descending order of the occurrence numbers, and records the motion mode and the occurrence number associated with each node, wherein the motion mode with the largest occurrence number associates with a head node, and the motion mode with the second largest occurrence number associates with a second node, and the rest may be deduced by analogy.

11. The apparatus in claim 8, wherein the determination module comprises:
a first determination sub-module, wherein the first determination sub-module compares the detected motion mode to the motion mode recorded in each node within the list of motion modes by a successive order starting from the head node, and determines whether the detected motion mode is one of the motion modes within the list of motion mode.

12. The apparatus in claim 11, wherein the determination module further comprises:
a second determination sub-module, wherein based on a determination that the detected motion mode is none of the motion modes within the list of motion modes, the second determination sub-module determines whether the length of the list of motion modes exceeds a set maximum length; upon a determination that the length of the list of motion modes does not exceed the set maximum length, the second determination sub-module directly appends the detected motion mode as a new motion mode to the end of the list of motion modes, and records the occurrence number associated with the new motion mode as one in the list of motion modes; upon a determination that the length of the list of motion modes exceeds the set maximum length, the second determination sub-module firstly removes the motion mode with the least occurrence number from the list of motion modes, and secondly appends the detected motion mode as a new motion mode to the end of the list of motion modes and records the occurrence number associated with the new motion mode as one in the end node.

13. The apparatus in claim 8, wherein the determination module comprises:
a third determination sub-module, wherein the third determination sub-module determines the degree of similarity between the detected motion mode and each motion mode within the list of motion modes;
a first decision sub-module, wherein upon a determination that the degree of similarity between the detected motion mode and one of the motion modes within the list of motion modes is equal or greater than a pre-set value, the first decision sub-module decides that the detected motion mode is said motion mode; and
a second decision sub-module, wherein upon a determination that the degree of similarity between the detected motion mode and any of the motion modes within the list of motion modes is less than the pre-set value, the second decision sub-module decides that the detected motion mode is none of the motion modes within the list of motion modes.

14. The apparatus in claim 13, further comprising:
a second record module, wherein the second record module records a characteristic value associated with the detected motion mode with a maximum occurrence number to a library of historical characteristic values of the same motion mode;
a determination module, wherein the determination module determines a mean value of the characteristic values of the same motion mode from the historical characteristic values of the same motion mode as the characteristic value associated with the node within the list of the motion modes for use in next detection; and
a third record module, wherein when next detection starts, upon a determination that a difference between the characteristic value of the detected motion mode and the mean value of the characteristic values of the same motion mode is less than a pre-set difference value, the third record module records the occurrence number associated with the detected motion mode as one.
